(19) United States
(12) Patent Application Publication
(10) Pub. No.: US 2026/0358220 A1
(43) Pub. Date: Nov. 12, 2026

(54) Combi-Rheometer Device for Determining Rheological Properties of Samples, Method for Calibrating a Combi-Rheometer Device

(71) Applicant: NETZSCH-Gerätebau GmbH, Selb (DE)

(72) Inventors: Florian Rummel, Selb (DE); Rebekka Taubmann, Selb (DE); Sabrina Küspert, Selb (DE); Johannes Dunkel, Rehau (DE); Levente Szántó, Hof (DE)

(21) Appl. No.: 19/657,238

(22) Filed: Apr. 24, 2026

(30) Foreign Application Priority Data
May 6, 2025 (DE) 10 2025 117 324.9

(51) Int. Cl. G01N 11/04; G01N 11/14; G01N 11/00

(52) U.S. Cl. CPC G01N 11/04; G01N 11/14; G01N 2011/0006

(57) ABSTRACT

A combi-rheometer device for determining rheological properties of samples, including first means for carrying out rotary-rheometric measurements, second means for carrying out capillary-rheological measurements, a shared drive unit and a shared control module with control program which can be provided and used in a user-defined manner in each case both for the first means and for the second means for the purpose of the respective measurements. In addition, a method for calibrating a combi-rheometer device is presented.

### TECHNICAL FIELD

The present invention relates to a combi-rheometer device for determining rheological properties of samples and a method for calibrating a combi-rheometer device.

### BACKGROUND

For the rheological characterization of materials, numerous instruments and implements are available to scientific plants, but also productive and processing industrial plants, in order to determine the desired information by means of suitable measuring methods, for example shear-rheology methods, extensional-rheology methods or pvt methods (pvt = pressure, volume, temperature). As an example of frequently used standard appliances, mention may be made for example of known rotary rheometers or else high-pressure capillary rheometers.

These last-mentioned implements can sometimes in each case require a particular space requirement in order to be able to carry out the desired measurements. Also, each procured appliance in the measurement laboratory or else in comparable facilities in industry, for example in the quality department or the like, represents a certain investment. In this respect, there is a desire and a certain need for rheological appliances or instruments which are conceived on the one hand to be space-saving and furthermore are configured in a highly functional manner, so that as many tasks as possible can be carried out on them.

### SUMMARY

Against this background, the present invention is based on the object of providing a combi-rheometer device and an associated method which at least proportionally overcome the previously mentioned disadvantages.

This object is achieved by a combi-rheometer device with the features, as well as by a method, with the features disclosed in the patent claims.

Accordingly, a combi-rheometer device for determining rheological properties of samples is provided, which comprises first means for carrying out rotary-rheometric measurements, second means for carrying out capillary-rheological measurements, a shared drive unit and a shared control module with control program. The drive unit and the control module with control program can be provided and used in a user-defined manner in each case both for the first means and for the second means for the purpose of the respective measurements.

Furthermore, a method is provided for calibrating a combi-rheometer device according to the invention, which comprises: providing and activating a combi-rheometer device according to the invention, carrying out rotary-rheometric measurements or capillary-rheological measurements, wherein in each case no sample is inserted, determining results of the measurements, storing the results of the measurements in the control module with control program, so that these results can be provided for following measurements with samples.

One idea on which the invention is based consists in producing a combi-appliance or a suitable device, using which different rheological measuring methods can be carried out, wherein a space-saving technical concept is to be favoured.

The presented invention advantageously combines these previously mentioned requirements in the presented combi-rheometer device, in that the carrying out of both rotary-rheometric measurements and the carrying out of capillary-rheological measurements are possible on the appliance according to the invention or on the device.

Since shared components are provided for respective measurements, a space-saving concept can additionally advantageously be produced. Since shared components are provided, manufacturing costs can additionally be saved, so that an inexpensive combi-rheometer device according to the invention can therefore also advantageously be produced.

The previously mentioned advantages also apply, insomuch as they can be transferred, for the presented method. The method can for example be stored as a constituent of the control program on the combi-rheometer device, so that a change between the respective rheological measuring methods can be carried out easily and in a user-friendly manner and advantageously at any time.

Since first information can be determined by means of the presented method without respectively inserted samples, it is possible in an advantageous manner to determine residual friction effects between plunger and vessel walls, in order to then take this information into account for actual measurements on inserted samples.

This can likewise take place depending for example on a temperature, particularly an ambient temperature, in the case of rotary-rheometric measurements depending on a rotational speed of the corresponding components and in the case of capillary-rheological measurements also depending on a vertical speed of the corresponding components.

According to an exemplary embodiment of the combi-rheometer device, it is provided that the first and second means in each case proportionally comprise components, which are provided in a respective first module for rotary-rheometric measurements and a second module for capillary-rheological measurements, which are in each case configured to be placeable in the combi-rheometer device, wherein the combi-rheometer device is configured to accommodate either the first or the second module in a reversible manner, so that depending on the placed first or second module, rotary-rheometric measurements or capillary-rheological measurements can be carried out on samples.

In this manner, depending on the desired rheological measurements that are to be carried out, corresponding components can be placed in the combi-rheometer device in a directly available manner, in order then subsequently to allow the shared constituents to interact with the respective module.

The respectively other module can in this case be placed at a different location, so that the space required for the measurements that are currently to be carried out is limited for the combi-rheometer device to the variant that is set up. The respectively inactive module can, for example in the removed state for maintenance purposes or cleaning purposes, be removed from an installation location of the combi-rheometer device. Also, a module that is respectively not currently used can be stored outside the combi-rheometer device, for example even in a different room or the like, so that the space for the active part of the combi-rheometer device can correspondingly be reduced.

According to a development of the combi-rheometer device, it is provided that the shared drive unit and the shared control module with control program are in each case a fixed constituent of the combi-rheometer device, so these components can be functionally provided to the first or the second placed module in each case.

A fixed installation location or a fixed constituent are advantageous in particular because an alignment of components of these modules can thus be carried out in a particularly reliable and therefore user-friendly manner in the event of a change of the two modules.

According to an exemplary embodiment of the combi-rheometer device, it is provided that the drive unit comprises a connecting unit with an exchangeable plunger unit which is configured to transmit movement pulses of the drive unit to the respective first or second means in a user-defined manner, so that owing to the transmission of user-defined movement pulses, respective rheological measurements can be carried out, wherein the movement pulses are selected from: rotary movement pulses, vertical movement pulses, horizontal movement pulses, rotary and simultaneously vertical movement pulses.

The respective means can therefore be provided in a more defined manner with necessary movement pulses for their respective rheological measurements or rheological measuring methods that can be provided. In particular, the specifically listed movement pulses can therefore be transmitted to the respective means in a more targeted manner and with high precision, so that the rheological measurements that are carried out can bring about particularly reliable measurement results. Owing to the exchangeable plunger unit, it is additionally advantageously possible to provide a combi-rheometer device that can be used in a particularly flexible manner. In other words, the combi-rheometer device can be adjusted in a particularly flexible manner for measuring methods that are respectively to be carried out owing to different plunger units that are to be used.

According to an exemplary embodiment of the combi-rheometer device according to the invention, it is provided that the combi-rheometer device comprises at least one sensor apparatus that is coupled with the control module, which sensor apparatus is configured to be providable and usable in a user-defined manner for the carrying out of rotary-rheometric measurements or for the carrying out of capillary-rheological measurements.

In addition to the measured values that can be determined by means of the drive unit, additional measured values can therefore be collected, which can then correspondingly be processed in the control module with control program. Beyond the display of respective values that have been determined, the display of combined and calculated measurement results is therefore also advantageously possible.

According to a development of the combi-rheometer device, it is provided that the exchangeable plunger unit is selected from: plunger unit which is configured to be usable for rotary-rheometric measurements, plunger unit which is configured to be usable for capillary-rheological measurements, plunger unit which is configured to be usable for rotary-rheometric measurements or capillary-rheological measurements, plunger unit with exchangeable ring seal element, which is configured to be usable for capillary-rheological measurements, plunger unit with exchangeable ring seal element, which is configured to be usable for rotary-rheometric measurements or capillary-rheological measurements.

Owing to the respective usable plunger units, it is possible to provide a combi-rheometer device that can be used in a particularly flexible manner. The respective plunger units can for example be provided in a set belonging to the combi-rheometer device, from which a user can then select the suitable plunger unit for the combi-rheometer device prior to a respective measurement. Plunger units with a respectively exchangeable ring seal element can help to reduce frictions that occur in each case, which can occur during the interaction with the respective means, so that possible disruptive influences of these frictions can be reduced to a minimum during measuring procedures. The plunger unit can in this case respectively comprise an upper plate or an upper cone or any further upper geometry. In particular, an adapter device for an upper available geometry unit can in this case also be provided, which makes it possible to accommodate syringe device plungers or the like for example. An accommodation of syringe plungers can also take place in holders that are specially provided for this purpose. It is in addition conceivable that the respective plunger unit is to be configured such that it may be possible to effect complete emptying and thus measuring procedures that are free from volume loss.

According to another exemplary embodiment of the combi-rheometer device, it is provided that the exchangeable plunger unit comprises a clamping device which can be adjusted in a user-defined manner and which is configured to clamp an end region of a syringe so that a plunger of the syringe device can be moved in a user-defined manner by means of the transmitted movement pulses, so that capillary-rheological measurements can be carried out.

Such an adjustable clamping device can therefore make it possible to clamp a very wide range of sizes of end regions of very different syringe devices, for example in the form of injection syringes (for example in the form of insulin syringes) or the like, so that then samples, which are present inside the respective syringe devices, can be investigated using the combi-rheometer device quickly and advantageously. In other words, a clamped end region of a syringe device can be provided such that a plunger of the clamped syringe can then be moved downwards in a defined manner by means of the drive unit, so that rheological measurements can be carried out.

According to a further exemplary embodiment of the combi-rheometer device, it is provided that the second module for capillary-rheological measurements comprises at least one vessel for accommodating a sample, wherein at least one exchangeable nozzle device is placeable at an end region of a respective vessel, so that a sample inserted in the respective vessel can be moved through the at least one nozzle device by means of the shared drive unit for the purpose of capillary-rheological measurements.

This module-like design variant enables a multiplicity of measuring arrangements, particularly on the basis of the exchangeable nozzle devices, so that it is possible to produce a combi-rheometer device which can be used in a most highly flexible manner.

Since a plurality of vessels can also be provided, into which the drive unit can correspondingly transmit its movement pulses in each case, for example by means of the connecting unit with exchangeable plunger unit, it is in addition possible to provide a particularly user-friendly combi-rheometer device.

Respective vessels can be filled with respective samples prior to the actual measurements, so that respective samples in the respective vessels can subsequently successively be moved through the at least one nozzle device by means of the drive unit.

Respective evaluations of detected correlations between behaviours of the drive unit and forces that are to be employed can then be processed for the capillary-rheological measurements in the control module with control program. Optionally, values of sensor apparatuses that are possibly present can also be taken into account in this case.

According to a further exemplary embodiment of the combi-rheometer device, it is provided that the second module for capillary-rheological measurements comprises at least one vessel and wherein respective internal walls of the at least one vessel are coated with a coating material, wherein the coating material is selected from: hydrophilic coating material, hydrophobic coating material, low-wear coating material, coating material with user-defined frictional properties.

In this manner, frictional processes between a plunger unit introduced into the respective vessel for moving the inserted sample and the vessel internal wall of the respective vessel, which frictional processes are possibly to be considered as disruptive, are minimized so that measuring procedures can be carried out more precisely in an advantageous manner. A coating material with user-defined frictional properties can in this context be understood to mean any material which is consciously provided owing to its particular, in particular measurable, frictional properties, so that a desired technical effect can be provided. If coatings are provided or selected, this can be provided accordingly in an application-dependent manner.

According to another exemplary embodiment of the combi-rheometer device, it is provided that the second module for capillary-rheological measurements comprises at least one optical measuring apparatus which is coupled with the control module and which is designed to detect samples emerging from a subregion of the second module, wherein the optical measuring apparatus is selected from: laser-based optical measuring apparatus, camera-based optical measuring apparatus.

The combi-rheometer device that is thus to be advantageously upgraded can optionally provide measurements of a die swell (also known as so-called swell measurement) or the like, so that even more extensive capillary-rheological measurements can be carried out. Accordingly, the control module with control program can in this context be designed for these purposes, so that, taking all measured values into account, it is possible to provide detailed information about the measurement results that are obtained.

According to a further exemplary embodiment of the combi-rheometer, it is provided that the second module for capillary-rheological measurements comprises a container which is filled in a user-defined manner with a gas mixture or a liquid or a solid body, in particular a sponge body, with accommodated gas mixture or a solid body, in particular a sponge body, with accommodated liquid, and which is designed to accommodate emerging samples.

Thus, it is possible that samples or the discharge thereof after leaving a corresponding component, for example in the form of a vessel or the like, of the second module, for example through a nozzle device or cannula or the like, can be transferred in a defined manner into the container with a gas mixture, which for example simply corresponds substantially to a composition of the surrounding indoor air, wherein a behaviour that occurs in the process can be observed. This information can subsequently be used for calculation processes of the measurement results.

Optionally, a particular gas composition can be provided, for example in order to change a sample/gas boundary surface in the event of emergence or discharge of the sample from a subregion of the second module and thus for example to reduce interfacial tensions and thus, as a priority, to investigate bulk properties of the sample or to obtain further measurement results for determining rheological information. With the same motivation, the discharge can optionally take place into a volume with a liquid or into a solid body that is filled with gas or liquid, such as a moist sponge or the like.

According to another exemplary embodiment of the combi-rheometer device, it is provided that the at least one nozzle device is selected from: nozzle device (19) having an opening with a diameter of at least 10 μm; nozzle device with an opening between 0.01 and 2 mm; injection needle with an internal diameter between 0.01 and 2 mm; injection needle with an internal diameter between 0.01 and 2 mm and with a length between 1 and 23 mm; injection needle with an internal diameter between 0.01 and 2 mm, wherein internal walls of the injection needle are at least proportionally coated with a coating material, wherein the coating material is selected from: hydrophilic coating material, hydrophobic coating material, low-wear coating material, coating material with user-defined frictional properties; injection needle with an internal diameter of at least 10 μm, in particular between 0.01 and 2 mm and with a length of at least 10 μm, in particular between 1 and 23 mm, wherein internal walls of the injection needle are at least proportionally coated with a coating material, wherein the coating material is selected from: hydrophilic coating material, hydrophobic coating material, low-wear coating material, coating material with user-defined frictional properties.

In this manner, measurements can be carried out, which have a high practical relevance, so that a direct use of the combi-rheometer device according to the invention can advantageously be achieved. Coated internal walls can possibly at least reduce frictions that are perceived to be disruptive, so that existing material properties of the inserted samples can be determined in a more targeted manner by means of the measurements that are carried out.

According to a further exemplary embodiment of the combi-rheometer device, it is provided that the at least one sensor apparatus that is coupled with the control module is selected from: sensor apparatus for measuring forces, sensor device for measuring pressures, sensor device for measuring forces and for measuring pressures.

Instead of only detecting and processing operating parameters of the drive unit, it is possible by means of the provided special sensor device to collect directly readable parameters for a user so that a more user-friendly combi-rheometer device can be provided.

According to another exemplary embodiment of the combi-rheometer device, it is provided that the respective exchangeable plunger units are externally at least proportionally coated with a coating material, wherein the coating material is selected from: hydrophilic coating material, hydrophobic coating material, low-wear coating material, coating material with user-defined frictional properties.

Coated external walls can possibly at least reduce frictions that are perceived to be disruptive, so that measurements can determine material properties of the inserted samples even better. In other words, the exchangeable plunger units can be provided in an at least proportionally coated manner at corresponding friction surfaces, so that for example a wettability with sample materials can be changed or in order to minimize friction generally at contact regions between respective plunger units and respective vessel internal walls.

According to a further exemplary embodiment of the combi-rheometer device, it is provided that the combi-rheometer device comprises at least one cleaning device which is configured to clean the connecting unit with the exchangeable plunger unit at least proportionally.

Such a cleaning device can therefore advantageously be used in order to benefit a user-friendly combi-rheometer device. Instead of manual cleaning, an advantageous at least proportionally automated cleaning of the cleaning unit with the exchangeable plunger unit can be effected by means of the cleaning device. If for example a plurality of vessels are provided in the combi-rheometer device, in which vessels different sample material is already kept in reserve for pending measurements, it is possible in each case to clean the connecting unit with the exchangeable plunger unit between the individual measurements by means of the cleaning device, so that the same conditions can be produced prior to each measurement, in particular a contamination of sample material can therefore reliably be prevented.

According to another exemplary embodiment of the combi-rheometer device, it is provided that the control module with control program comprises at least one calibration method, so that the combi-rheometer device can be calibrated prior to the measurements, so that rotary-rheometric measurements or capillary-rheological measurements can subsequently be carried out.

In this manner, a residual friction between respective plunger units and respective vessel internal wall can for example be determined prior to the measurements, so that this information can advantageously be used for later evaluation procedures of rheological measurements.

Also, calibration methods can be conceived, which take very well-known sample material into account, so that residual frictions that are established in connection with plunger units, vessel internal walls and liquid reference sample material, for example in the form of a particular and adequately known liquid, can be determined so that this information can advantageously be used for later evaluation procedures of rheological measurements.

These residual frictions can in this case be calibrated in particular methods as a function of for example temperature, rotational speed of the drive unit and vertical speed of the drive unit.

A respective calibration method can for example then store these determined values in the control module with control program in such a manner, so that these values can be subtracted from samples or generally taken into account in the actual rheological measurements. Optionally, a calibration method can also be provided, which provides calibrations without inserted sample material.

Alternatively, a calibration can first take place taking into account a respective sample or a known sample material of a calibration sample or the like and subsequently a calibration can then take place without inserted sample material, wherein the method is correspondingly to be adapted for these processes in each case. All collected values can subsequently be stored in such a manner that a selection of a manner of calibration can be selected in a user-defined manner.

According to another exemplary embodiment of the method for calibrating a combi-rheometer device according to the invention, such a method furthermore comprises: providing a sample which comprises a defined quantity of a rheologically known sample material, inserting the sample into the combi-rheometer device according to the invention, determining results of the measurements, storing the results of the measurements in the control module with control program, so that these results can be provided for following measurements with samples.

Since by means of the presented method in this variant, further information can be determined with respectively inserted samples, which in each case comprise a defined quantity of a rheologically known sample material, residual friction effects between plunger and vessel walls and the known sample material, particularly a sample material of a substantially liquid nature, can advantageously be determined in order then to take this information into account for actual measurements on inserted samples.

In other words, the residual friction can be determined with respect to a correlation between plunger/vessel wall/fluid, so that these collected measured values can be used for the calibration method according to the invention.

This can likewise take place depending for example on a temperature, particularly an ambient temperature, in the case of rotary-rheometric measurements depending on a rotational speed of corresponding components and in the case of capillary-rheological measurements also depending on a vertical speed of corresponding components.

### BRIEF DESCRIPTION OF THE DRAWINGS

The invention is explained in the following with reference to the figures of the drawings. In the figures:

FIG. 1 shows a schematic side view of a combi-rheometer device according to an exemplary embodiment of the present invention;

FIG. 2 shows a schematic detail view of a first module for rotary-rheometric measurements of a combi-rheometer device according to an exemplary embodiment of the present invention;

FIG. 3 shows a schematic detail view of a second module for capillary-rheological measurements of a combi-rheometer device according to an exemplary embodiment of the present invention;

FIG. 4 shows a schematic detail view of a further second module for capillary-rheological measurements of a combi-rheometer device according to an exemplary embodiment of the present invention;

FIG. 5 shows a schematic perspective view of a further second module for capillary-rheological measurements of a combi-rheometer device according to an exemplary embodiment of the present invention;

FIGS. 6a–c show schematic detail views of connecting units with exchangeable plunger units of a combi-rheometer device according to exemplary embodiments of the present invention;

FIG. 7 shows a schematic flow chart of a method for calibrating a combi-rheometer device according to an exemplary embodiment of the present invention.

In the figures, the same reference symbols designate the same or functionally identical components, to the extent that nothing to the contrary is stated.

### DETAILED DESCRIPTION

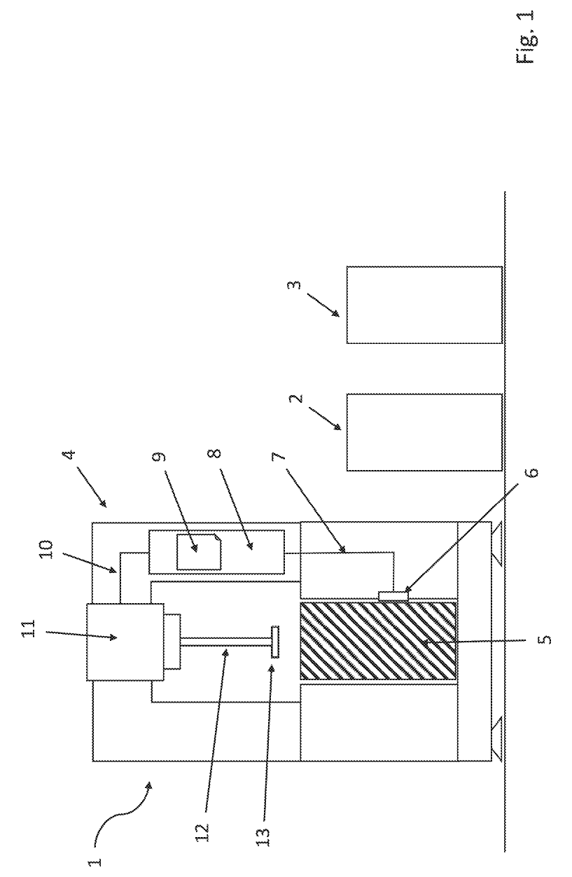

FIG. 1 shows a schematic side view of a combi-rheometer device 1 according to an exemplary embodiment of the present invention. The illustrated combi-rheometer device 1 for determining rheological properties of samples in this case comprises first means for carrying out rotary-rheometric measurements and second means for carrying out capillary-rheological measurements, which are in each case illustrated in a first module 2 for rotary-rheometric measurements and a second module 3 for capillary-rheological measurements.

The two modules 2, 3 are illustrated in the removed state next to a base body 4 of the combi-rheometer device 1. The two modules 2, 3 are in each case configured to be placeable in the combi-rheometer device 1, wherein the combi-rheometer device 1 is correspondingly configured to accommodate either the first or the second module 2, 3 in a reversible manner, so that rotary-rheometric measurements or capillary-rheological measurements can be carried out on samples depending on the placed first or second module 2, 3.

In FIG. 1, a hatched area is illustrated in the base body 4 of the combi-rheometer device 1 as a placeholder 5 for the two modules 2, 3. The two modules 2, 3 can in each case be fitted in this placeholder 5 of the base body 4 individually and depending on the desired function of the combi-rheometer device 1 or functionally coupled as such, so that depending on the placed first or second module 2, 3, rotary-rheometric measurements or capillary-rheological measurements can be carried out on samples.

With respect to the image plane, a coupling unit 6 is illustrated on the right side of the base body 4, which is configured to couple either the first or the second module 2, 3 with a control module 8 with control program 9 of the combi-rheometer device 1 by means of a first connecting line 7. Also, this coupling unit 6 can be configured correspondingly to supply the first or the second module 2, 3 with energy or the like, which can correspondingly be supplied by the base body 4 of the combi-rheometer device 1, which is coupled with an energy source for these purposes.

The control module 8 with control program 9 is in turn connected by means of a second connecting line 10 to a drive unit 11 of the combi-rheometer device 1. Both the drive unit 11 and the control module 8 with control program 9 are configured to be shared by the first or second module 2, 3. In other words, depending on the placed module 2, 3, both the drive unit 11 and the control module 8 with control program 9 can be used either with the first module 2 for carrying out rotary-rheometric measurements or with the second module 3 for carrying out capillary-rheological measurements, wherein both shared components are configured for these purposes in each case. The drive unit 11 can for example comprise a corresponding gear unit in order therefore to be adjustable in a user-defined manner for the two modules 2, 3 for the purpose of the respective measuring procedures.

For example, a user can by means of the easiest adjustment procedures set up these two components for the pending measurements or generally activate them. Alternatively, automatic detection routines are conceivable, so that already during a placing procedure of the corresponding module 2, 3, the components automatically detect the placed module 2, 3 via signal transmission or else on the basis of mechanically effected adjustment procedures and carry out corresponding adjustments. Such adjustments can either be carried out carried out exclusively for the two shared components or alternatively also in the respective module 2, 3.

Illustrated below the drive unit 11 (with respect to the image plane) is a connecting unit 12 with an exchangeable plunger unit 13.

This connecting unit 12 with the exchangeable plunger unit 13 is in this case configured to transmit movement pulses of the drive unit 11 to the respective first or second means in the form of the two modules 2, 3 in a user-defined manner, so that owing to the transmission of user-defined movement pulses, respective rheological measurements can be carried out.

The movement pulses to be transmitted can in this case be selected from the following options: rotary movement pulses, vertical movement pulses, horizontal movement pulses, rotary and simultaneously vertical movement pulses.

Thus, it is for example conceivable that in the case of a placed first module 2 for carrying out rotary-rheometric measurements, rotary and simultaneously vertical movement pulses can be transmitted and in the case of a placed second module 3 for example, only vertical or horizontal movement pulses can be transmitted. The drive unit 11 can comprise gear devices for that, which are not illustrated in more detail, or the like, so that for examples movements of an electric motor unit or the like can be converted in the drive unit 11 into respectively required movement pulses. Thus, it is for example conceivable that such an electric motor unit is formed in the form of a stepping motor unit, particularly as a synchronous motor unit or as a reluctance motor unit. Alternative drive units are also conceivable.

Thus, the drive unit 11 can for example also comprise a perfusion pump in order for example to enable vertical movements and thus to move the connecting unit 12 with the exchangeable plunger unit 13 downwards or upwards. In general, in the case of vertical movements, it is possible to measure a force that is to be employed, in order then to determine rheological measurements by means of these determined parameters and supply them. To this end, at least one force measuring device, which can also be referred to in general as a sensor unit or force sensor unit, can for example be employed or advantageously be used. Based on such force measurements, any shear stresses that occur or the like can be determined or calculated.

Thus, the drive unit 11 can be used in any design for rotary or oscillation movements, in order optionally to oscillate or to rotate a plunger of the exchangeable plunger unit 13. Also, it is also conceivable in this context that residual friction between exchangeable plunger unit 13 or an associated plunger of this exchangeable plunger unit 13 and a vessel wall can therefore be reduced by means of a thus-realized movement at a user-defined speed. This can for example take place by means of the use of an optimum in the style of a Stribeck curve or the like, which may be characteristic for the respective pairing of plunger and vessel wall and sample, particularly a substantially liquid sample or a corresponding fluid.

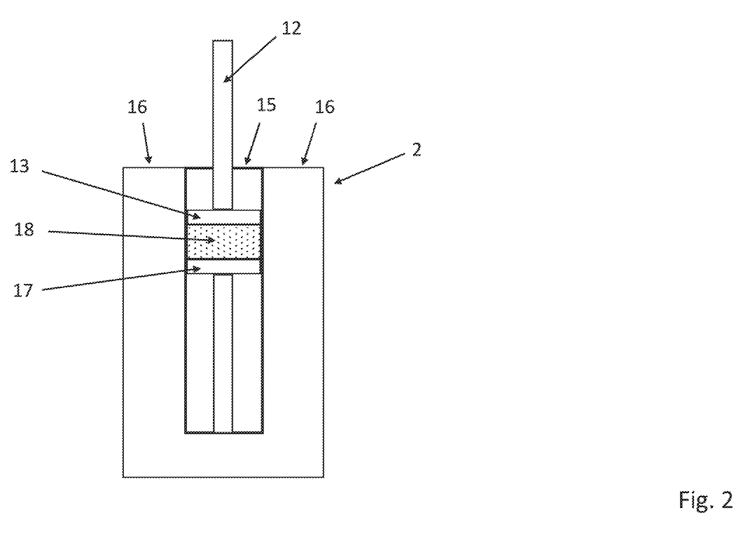

FIG. 2 shows a schematic detail view of a first module 2 for rotary-rheometric measurements of a combi-rheometer device 1 according to an exemplary embodiment of the present invention.

In this case, this is a first module 2, as can be placed for example in the combi-rheometer device 1 illustrated in FIG. 1, so that rotary-rheometric measurements can subsequently be carried out. A vessel 14 is illustrated centrally in this sectional view, which vessel can have an opening 15 towards the top (with respect to the image plane), so that it is open at the top, wherein in this specific embodiment, this opening 15 is inserted essentially into an upper delimiting surface 16 of the illustrated first module 2 that surrounds it. Alternatively, it is conceivable that the vessel 14 is placed in such a manner so that this opening 15 is located (with respect to the image plane) above this surrounding upper delimiting surface 16 of the illustrated first module 2. In other words, the vessel 14 can also protrude at least proportionally out of the first module 2, so that for example a removal procedure or the like can advantageously be carried out more easily for a user of the combi-rheometer device 1 according to the invention.

The vessel 14 has essentially a cylindrical shape and is illustrated with a base plate 17 that is mounted in a movable manner, on which base plate a placed sample 18 can be seen. With respect to the image plane, a connecting unit 12 with exchangeable plunger unit 13 of the combi-rheometer device 1 is placed on the sample 18, so that the sample 18 or the sample material that constitutes it can be provided in a clamped manner between the exchangeable plunger unit 13 and the base plate 17, so that rotary-rheometric measurements can be carried out.

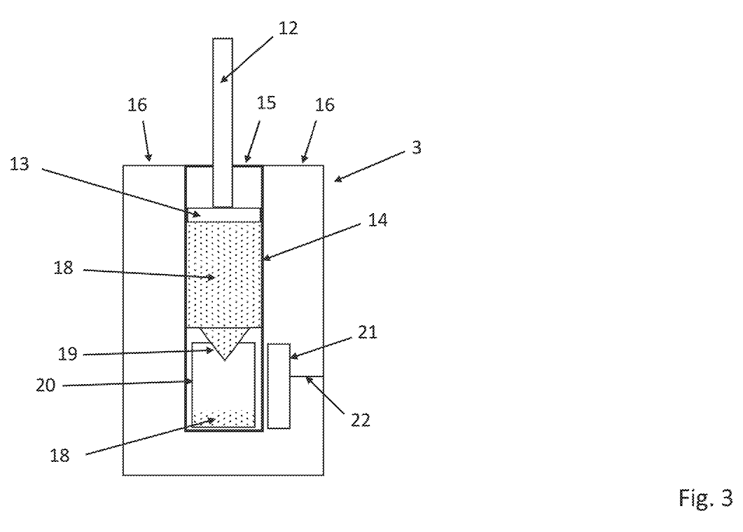

FIG. 3 shows a schematic detail view of a second module 3 for capillary-rheological measurements of a combi-rheometer device 1 according to an exemplary embodiment of the present invention.

In this case, this is a second module 3, as can be placed for example in the combi-rheometer device 1 illustrated in FIG. 1, so that capillary-rheological measurements can subsequently be carried out. A vessel 14 is illustrated centrally in this sectional view, which vessel can have an opening 15 towards the top (with respect to the image plane), so that it is open at the top, wherein in this specific embodiment, this opening 15 is inserted essentially into an upper delimiting surface 16 of the illustrated second module 3 that surrounds it.

The vessel 14 essentially has a cylindrical shape and is illustrated with an exchangeable nozzle device 19, which (with respect to the image plane) is located arranged essentially in the lower third on the vessel 14, so that a sample 18 placed in the vessel 14 can be conveyed through this nozzle device 19. Above the sample 18 (with respect to the image plane), a connecting unit 12 with exchangeable plunger unit 13 of the combi-rheometer device 1 is illustrated placed on the sample 18, so that the sample 18 or the sample material constituting it is located between the exchangeable plunger unit 13 and the nozzle device 19, so that in the activated state of the drive unit 11, which is not illustrated in any more detail, capillary-rheological measurements can be carried out by pressing the sample 18 out through the nozzle device 19 in a defined manner.

The nozzle device 19 can in this case for example be selected from the following exemplary embodiments: nozzle device 19 having an opening with a diameter of at least 10 μm; nozzle device with an opening between 0.01 and 2 mm; injection needle with an internal diameter between 0.01 and 2 mm; injection needle with an internal diameter of at least 10 μm, in particular between 0.01 and 2 mm and with a length of at least 10 μm, in particular between 1 and 23 mm; injection needle with an internal diameter between 0.01 and 2 mm, wherein internal walls of the injection needle are at least proportionally coated with a coating material, wherein the coating material is selected from: hydrophilic coating material, hydrophobic coating material, low-wear coating material, coating material with user-defined frictional properties. ; injection needle with an internal diameter between 0.01 and 2 mm and with a length between 1 and 23 mm, wherein internal walls of the injection needle are at least proportionally coated with a coating material, wherein the coating material is selected from: hydrophilic coating material, hydrophobic coating material, low-wear coating material, coating material with user-defined frictional properties. hydrophilic coating material, hydrophobic coating material, low-wear coating material, coating material with user-defined frictional properties.

In further embodiments that are not illustrated in any more detail, it is conceivable that a nozzle design of any nozzle device can be configured to be flexible with regards to at least a material selection and shaping, depending on the use case. Particularly in the case of very low viscosity samples and/or in the case of samples that should be measured at relatively low shear rates, it should be possible to extend the nozzle length to for example 100 mm or optionally considerably longer. For example glass capillaries or suitable hoses (for example with a particular material compatibility, precision and so on) which can be used are conceivable. Optionally, the nozzle device can be provided similarly to a column several metres long and for example in a reeled up state. Optionally, it is additionally conceivable that dummy nozzles or the like can also be provided. Likewise, it is conceivable that in general any nozzle devices can advantageously be used, which can be used in connection with a high pressure capillary-rheometer device.

In a design variant, which is not illustrated in any more detail, it is additionally conceivable that more than one nozzle device 19 is provided. For example, these different nozzle devices, which are not illustrated in any more detail, then have different geometries for example with respect to outlet openings and are for example arranged above one another, so that depending on the test set-up and preceding calibration methods, further investigation options can be provided.

Below the illustrated nozzle device 19 in FIG. 3, a container 20 is illustrated, in which sample material of the sample 18 that has emerged from the nozzle device 19 can be captured, which can be seen indicated in the bottom region of the container 20.

This container 20 is illustrated in a self-contained manner in this case, so that is can be filled in a user-defined manner with a gas mixture or a liquid or a solid body, in particular a foam body, with accommodated gas mixture or a solid body, in particular a foam body, with accommodated liquid.

For example, the container 20 can be filled with indoor air in a simple variant. It is however conceivable that the container 20 is also filled with a gas mixture that is separately mixed for these purposes, which is primarily characterized in that, with respect to volume fractions, it is predominantly not indoor air.

The cohesion of the container 20 can be seen indicated in FIG. 3, since only the nozzle device 19 projects directly into an inner region of the container 20, wherein only the sample material of the sample 18 can therefore penetrate into this inner region from outside.

In this respect, a particular gas composition can optionally be provided, for example in order to change a sample/gas boundary surface in the event of emergence or discharge of the sample 18 from a subregion of the second module 3 and thus for example to reduce interfacial tensions and thus, as a priority, to investigate bulk properties of the sample 18 or to obtain further measurement results for determining rheological information.

With the same motivation, the discharge can optionally take place into a volume with a liquid or into a solid body that is filled with gas or liquid, such as a moist sponge or the like. The possibilities to carry out capillary-rheological measurements using the combi-rheometer device 1 according to the invention can thus be expanded as desired.

In FIG. 3, an optical measuring apparatus 21 is illustrated next to the container 20 for detecting this further information. This optical measuring apparatus 21 can for example be a laser-based optical measuring apparatus or for example a camera-based optical measuring apparatus.

Also, it is conceivable that both forms are provided in parallel, wherein any optical measuring apparatuses 21 that are provided is in each case to be coupled with the control module 8 of the combi-rheometer device 1.

The container 20 can in one design of the present invention for example have a test window area, so that the respective measuring apparatus 21 can correspondingly detect the internal sample material of the sample 18, so that the desired measurements can be carried out at this place using the combi-rheometer device 1 according to the invention.

Alternatively, in a further design it is conceivable that the container 20 is entirely constructed from a substantially light-permeable or generally constructed from a substantially transparent material, so that the desired measurements can be carried out at this place using the combi-rheometer device 1 according to the invention.

In FIG. 3, this is indicated by means of an illustrated third connecting line 22, wherein this third connecting line 22 is configured to be connected to a coupling unit 6 of the combi-rheometer device 1, which is not illustrated in any more detail, so that a coupling to the control module 8, which is likewise not illustrated in any more detail in FIG. 3, is therefore possible.

The respective optical measuring apparatuses 21 in their respective embodiments are in each case configured to detect a sample 18 emerging from a subregion of the second module 3, or to document a behaviour, for example a die swell, so that a corresponding preparation of this information can subsequently be carried out in the control module 8 with control program 9, in order to evaluate the capillary-rheological measurements that are carried out in a more detailed manner.

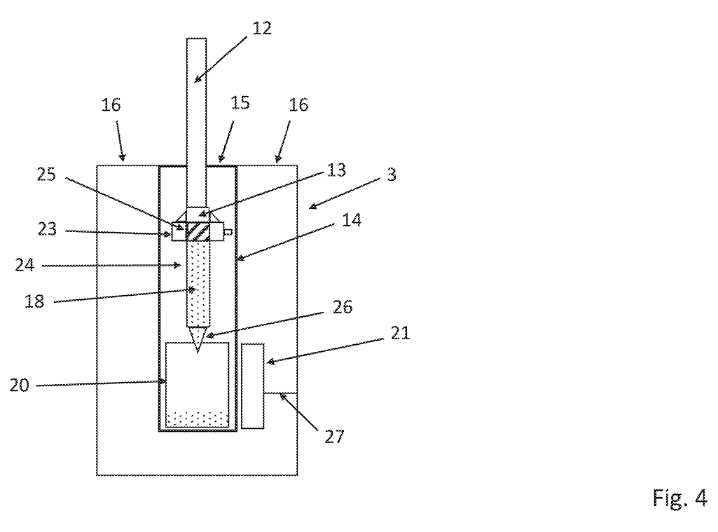

FIG. 4 shows a schematic detail view of a further second module 3 for capillary-rheological measurements of a combi-rheometer device 1 according to an exemplary embodiment of the present invention.

A vessel 14 is illustrated centrally in this sectional view, which vessel can have an opening 15 towards the top (with respect to the image plane), so that it is open at the top, wherein in this specific embodiment, this opening 15 is inserted essentially into an upper delimiting surface 16 of the illustrated second module 3 that surrounds it.

The vessel 14 essentially has a cylindrical shape. With respect to the image plane, in the upper third, a connecting unit 12 with exchangeable plunger unit 13 protrudes from the combi-rheometer device 1 into the vessel 14. The exchangeable plunger unit 13 has a clamping device 23 in this case. In the clamping device 23, a syringe device 24 is illustrated clamped, in which syringe device sample material drawn up from a sample 18 is provided.

This syringe device 24 is illustrated in a greatly simplified manner and can for example be provided in any form of a commercially available injection syringe, for example in the form of a insulin syringe, or the like. A plunger 25 of this syringe device 24 is illustrated clamped in the clamping device 23, so that in the event of a vertical movement of the connecting unit 12 with the exchangeable plunger unit 13, this plunger 25 can correspondingly be pushed downwards.

Thus, sample material of the sample 18 can be pushed out through an injection needle 26 of the syringe device 24 and capillary-rheological measurements can therefore be carried out.

The clamping device 23 can for example be a clamping device 23 with a simple spring mechanism or the like. Also, the clamping device 23 can comprise any mechanically adjustable clamping elements, so that user-defined adjustment procedures can be effected.

In this case, it can for example be provided that the syringe device 24 is encompassed in such a manner or generally clamped, so that the plunger 25 of the syringe device 24 can be pressed downwards in a user-defined manner for the purposes of capillary-rheological measurements and at the same time, the syringe device 24 is held in a stationary manner in the vessel 14. In other words, the clamping device 23 is configured in every embodiment to clamp an end region of a syringe device 24 such that by means of transmitted movement pulses, the plunger 25 of the syringe device 24 can be moved in a user-defined manner, so that capillary-rheological measurements can be carried out.

In this case, the syringe device 24 can be placed in a stationary manner in the combi-rheometer device 1, in particular in the vessel 14 of the second module 3, so that the forces transmitted to the plunger 25 are employed for the most part for pressing out sample material of the sample 18, which is drawn up in the syringe device 24.

In order to avoid friction, the syringe device 24 can in a design variant have corresponding coatings for friction reduction. It is however also conceivable that commercially available injection syringes or the like with already filled sample material are inserted in a user-defined manner in the combi-rheometer device 1 as described, so that capillary-rheological measurements can subsequently be carried out.

Below the injection needle 26 of the syringe device 24 in FIG. 4, a container 20 is illustrated, in which sample material of the sample 18 that has emerged from the injection needle 26 can be captured, which can be seen indicated in the bottom region of the container 20.

This container 20 is illustrated in a self-contained manner in this case, so that is can be filled in a user-defined manner with a gas mixture or a liquid or a solid body, in particular a foam body, with accommodated gas mixture or a solid body, in particular a foam body, with accommodated liquid.

For example, the container 20 can be filled with indoor air in a simple variant. It is however conceivable that the container 20 is also filled with a gas mixture that is separately mixed for these purposes, which is primarily characterized in that, with respect to volume fractions, it is predominantly not indoor air.

The cohesion of the container 20 can be seen indicated in FIG. 4, since only the injection needle 26 projects directly into an inner region of the container 20, wherein only the sample material of the sample 18 can therefore penetrate into this inner region from outside.

In this respect, a particular gas composition can optionally be provided, for example in order to change a sample/gas boundary surface in the event of emergence or discharge of the sample 18 from the second module 3 and thus for example to reduce interfacial tensions and thus, as a priority, to investigate bulk properties of the sample 18 or to obtain further measurement results for determining rheological information.

With the same motivation, the discharge can optionally take place into a volume with a liquid or into a solid body that is filled with gas or liquid, such as a moist sponge or the like. The possibilities to carry out capillary-rheological measurements using the combi-rheometer device 1 according to the invention can thus be expanded as desired.

In FIG. 4, an optical measuring apparatus 21 is illustrated next to the container 20 for detecting this further information. This optical measuring apparatus 21 can for example be a laser-based optical measuring apparatus or for example a camera-based optical measuring apparatus. Also, it is conceivable that both forms are provided in parallel, wherein any optical measuring apparatuses 21 that are provided are to be coupled with the control module 8 of the combi-rheometer device 1.

The container 20 can in one design of the present invention for example have a test window area, so that the respective measuring apparatus 21 can correspondingly detect the internal sample material of the sample 18, so that the desired measurements can be carried out at this place using the combi-rheometer device 1 according to the invention.

Alternatively, in a further design it is conceivable that the container 20 is entirely constructed from a substantially light-permeable or generally constructed from a substantially transparent material, so that the desired measurements can be carried out at this place using the combi-rheometer device 1 according to the invention.

In FIG. 4, a fourth connecting line 27 is illustrated indicated, wherein this fourth connecting line 27 is configured to be connected to a coupling unit 6 of the combi-rheometer device 1, which is not illustrated in any more detail, so that a coupling to the control module 8, which is likewise not illustrated in any more detail in FIG. 4, is therefore possible.

The respective optical measuring apparatuses 21 in their respective embodiments are in this case in each case configured to detect a sample 18 emerging from a subregion of the second module 3, or to document a behaviour, for example a die swell, so that a corresponding preparation of this information can subsequently be carried out in the control module 8 with control program 9, in order to evaluate the capillary-rheological measurements that are carried out in a more detailed manner.

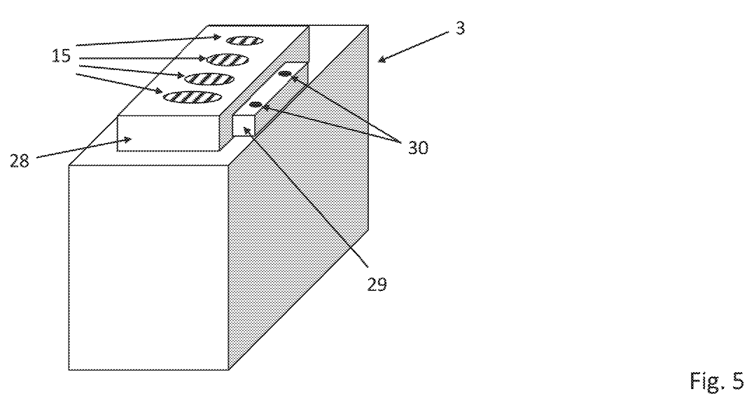

FIG. 5 shows a schematic perspective view of a further second module 3 for capillary-rheological measurements of a combi-rheometer device 1 according to an exemplary embodiment of the present invention.

In this perspective view, the second module 3 is only illustrated from outside. A multi-vessel module 28 protrudes above (with respect to the image plane) out of the second module 3 as a separate assembly. Instead of only one vessel 14, as shown in the preceding FIGS. 3 and 4, this illustrated multi-vessel module 28 has four openings 15 in total, in which four vessels 14 are correspondingly provided with corresponding measuring devices, as described for example in FIGS. 3 and 4.

For example, four structurally identical vessels 14 can therefore be provided with corresponding measuring devices, so that a connecting unit 12, which is not illustrated in any more detail, with the exchangeable plunger unit 13 can be moved into the respective opening 15 successively, so that the respective capillary-rheological measurements can accordingly be carried out by means of the presented combi-rheometer device 1. It is also conceivable that in each of the openings 15, a separately developed capillary-rheological measuring apparatus is provided, so that for example different variants of the variants presented and described in FIGS. 3 and 4 are provided, so that the respective capillary-rheological measurements can then be carried out by means of the presented combi-rheometer device 1.

A fastening device 29 is illustrated to the side of the multi-vessel module 28, by means of which the multi-vessel module 28 can be fastened. It can for example be provided that a structurally identical fastening device 29 is provided at the rear side, which cannot be seen in this perspective view. Instead of the two illustrated fastening elements 30, three or more can also be provided.

The respectively illustrated elongated rectangular shape is illustrated merely by way of example both for the multi-vessel module 28 and for the fastening device 29.

Thus, it is conceivable in a design variant, which is not illustrated in any more detail, that the multi-vessel module 28 has a substantially round shape, for example a circular shape, wherein the openings 15 are then provided in a circular arrangement.

Also, in each case more than four openings 15 can be provided, with vessels 14 with corresponding measuring devices correspondingly arranged therebelow. For example, approximately five or eight openings 15 can be provided, with vessels 14 with corresponding measuring devices correspondingly arranged therebelow. Also, only two openings 15 can be provided, with corresponding vessels 14 with corresponding measuring devices.

In this case, it is in each case conceivable that the multi-vessel module 28 is provided in a movable manner relative to the connecting unit 12, which is not illustrated in any more detail, with the exchangeable plunger unit 13. Thus, the illustrated elongated rectangular shape can for example be provided on rails or the like, so that a respective opening 15 with vessels 14 with corresponding measuring devices correspondingly arranged therebelow can then in each case be displaced such that, for the purpose of the capillary-rheological measurements, a substantially vertical (with respect to the image plane) movement of the connecting unit 12 with the exchangeable plunger unit 13 can then be carried out.

Subsequently, this connecting unit 12 with the exchangeable plunger unit 13 is in turn moved vertically upwards, the multi-vessel module 28 is shifted by one position and a further capillary-rheological measurement can be carried out in the newly aligned opening 15.

In a further alternative embodiment, it is conceivable that the multi-vessel module 28 is provided in a rigid manner and then the connecting unit 12 with the exchangeable plunger unit 13 can be moved by means of a drive unit 11, which is not illustrated in any more detail, horizontally (with respect to the image plane) or generally in a substantially horizontal plane, which for example extends parallel to the respective plane of the openings 15, so that the desired capillary-rheological measurements can be carried out successively in the respective openings 15 with vessels 14 with corresponding measuring devices correspondingly arranged therebelow.

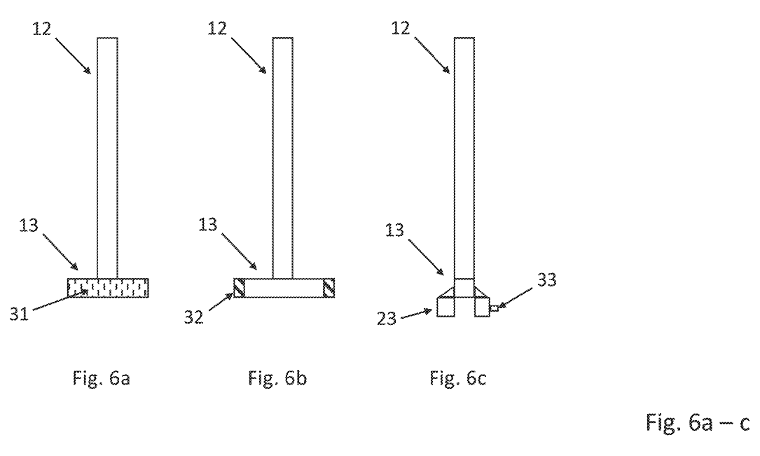

FIGS. 6a–c shows schematic detail views of connecting units 12 with exchangeable plunger units of 13 a combi-rheometer device 1 according to exemplary embodiments of the present invention.

With respect to the image plane, the FIGS. 6a, 6b and 6c are in this case illustrated from left to right, wherein respective connecting units 12 are illustrated equally and thus these FIGS. 6a–c only differ in terms of the exchangeable plunger unit 13.

In FIG. 6a, an exchangeable plunger unit 13 is illustrated with a coating 31, wherein this coating 31 is provided at least on all side regions of the exchangeable plunger unit 13. This coating 31 can for example comprise the following materials, which are selected from: ...

It is conceivable that either each of the listed materials is in each case provided alone as a corresponding coating 31. Alternatively, any mixtures of these listed materials are also conceivable. Thus, for example in the case of a mixture of three of these materials, a respective proportion of a third or the like can be provided.

In FIG. 6b, an exchangeable plunger unit 13 with a ring seal element 32 is illustrated, wherein this ring seal element 32 precisely encloses the plunger unit 13 externally. It is conceivable that this ring seal element 32 for example proportionally consists of an elastic material, so that it is pulled over or generally positionable precisely on the plunger unit 13.

In a further design, it is conceivable that this ring seal element 32 can be fastened on the plunger unit 13 by means of a commonly used joining method, for example by means of adhesive elements or materials or else by means of mechanical elements. Plunger units 13 with a respectively exchangeable ring seal element 32 can help to reduce frictions that occur in each case, which can occur during the interaction with the respective means, so that possible disruptive influences of these frictions can be reduced to a minimum during measuring procedures.

An exchangeable plunger unit 13 with a clamping device 23 is illustrated in FIG. 6c. This clamping device 23 can for example be configured to clamp a syringe device 24, which is not illustrated in any more detail, for example an injection syringe or the like. For example, this syringe device 24 can be clamped in the clamping device 23 or be provided in a clamped manner such that in the event of a vertical movement of the connecting unit 12 with the exchangeable plunger unit 13, a plunger 25 of this syringe device 24 can correspondingly be pressed downwards.

In this case, the clamping device 23 has a laterally positioned adjusting element 33, so that user-defined clamping procedures can be effected. Thus, it is conceivable in a design that the laterally positioned adjusting element 33 is provided by means of a spring mechanism that is not illustrated in any more detail. It is also conceivable that the laterally positioned adjusting element 33 comprises a screw mechanism, so that user-defined clamping procedures can correspondingly be effected.

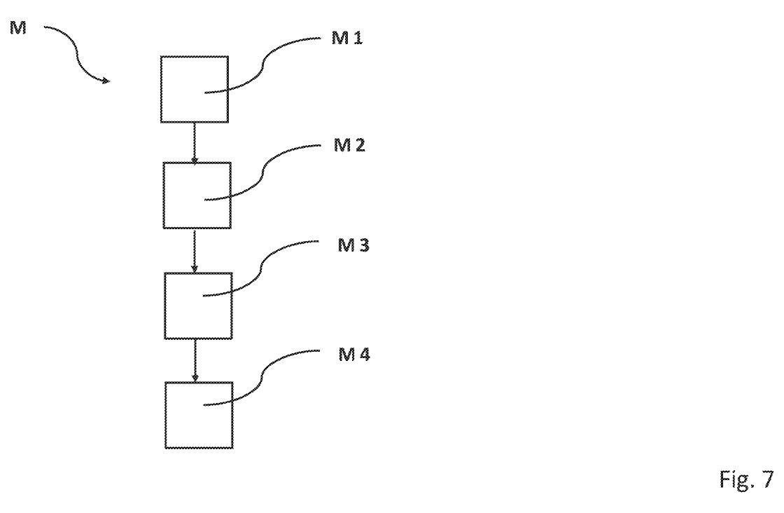

FIG. 7 shows a schematic flow chart of a method M for calibrating a combi-rheometer device 1 according to an exemplary embodiment of the present invention. In a first method step M1, a combi-rheometer device 1 according to the invention is provided and activated. In a second method step M2, rotary-rheometric measurements or capillary-rheological measurements are carried out, wherein in each case no sample is inserted. In a third method step M3, results of the measurements are determined. In a fourth method step M4, the results of the measurements are stored in the control module 8 with control program 9, so that these results can be provided for following measurements with samples.

In a design of this method M, which is not illustrated in any more detail, it is conceivable that the following further method steps are provided: providing a sample which comprises a defined quantity of a rheologically known sample material, inserting the sample into the combi-rheometer device 1, determining results of the measurements, storing the results of the measurements in the control module 8 with control program 9, so that these results can be provided for following measurements with samples.

1. A combi-rheometer device for determining rheological properties of samples, comprising first means for carrying out rotary-rheometric measurements, second means for carrying out capillary-rheological measurements, a shared drive unit and a shared control module with control program which can be provided and used in a user-defined manner in each case both for the first means and for the second means for the purpose of the respective measurements.

2. The combi-rheometer device according to claim 1, wherein the first and second means in each case proportionally comprise components, which are provided in a respective first module for rotary-rheometric measurements and a second module for capillary-rheological measurements, which are in each case configured to be placeable in the combi-rheometer device, wherein the combi-rheometer device is configured to accommodate either the first or the second module in a reversible manner, so that depending on the placed first or second module, rotary-rheometric measurements or capillary-rheological measurements can be carried out on samples.

3. The combi-rheometer device according to claim 2, wherein the shared drive unit and the shared control module with control program are in each case a fixed constituent of the combi-rheometer device, so these components can be functionally provided to the first or the second placed module in each case.

4. The combi-rheometer device according to claim 1, wherein the drive unit comprises a connecting unit with an exchangeable plunger unit which is configured to transmit movement pulses of the drive unit to the respective first or second means in a user-defined manner, so that owing to the transmission of user-defined movement pulses, respective rheological measurements can be carried out, wherein the movement pulses are selected from: rotary movement pulses, vertical movement pulses, horizontal movement pulses, rotary and simultaneously vertical movement pulses.

5. The combi-rheometer device according to claim 1, wherein the combi-rheometer device comprises at least one sensor apparatus that is coupled with the control module, which sensor apparatus is configured to be providable and usable in a user-defined manner for the carrying out of rotary-rheometric measurements or for the carrying out of capillary-rheological measurements.

6. The combi-rheometer device according to claim 4, wherein the exchangeable plunger unit is selected from: plunger unit which is configured to be usable for rotary-rheometric measurements, plunger unit which is configured to be usable for capillary-rheological measurements, plunger unit which is configured to be usable for rotary-rheometric measurements or capillary-rheological measurements, plunger unit with exchangeable ring seal element, which is configured to be usable for capillary-rheological measurements, plunger unit with exchangeable ring seal element, which is configured to be usable for rotary-rheometric measurements or capillary-rheological measurements.

7. The combi-rheometer device according to claim 4, wherein the exchangeable plunger unit comprises a clamping device which can be adjusted in a user-defined manner and which is configured to clamp an end region of a syringe device so that a plunger of the syringe device can be moved in a user-defined manner by means of the transmitted movement pulses, so that capillary-rheological measurements can be carried out.

8. The combi-rheometer device according to claim 2, wherein the second module for capillary-rheological measurements comprises at least one vessel for accommodating a sample, wherein at least one exchangeable nozzle device is placeable at an end region of a respective vessel, so that a sample inserted in the respective vessel can be moved through the at least one nozzle device by means of the shared drive unit for the purpose of capillary-rheological measurements.

9. The combi-rheometer device according to claim 2, wherein the second module for capillary-rheological measurements comprises at least one vessel and wherein respective internal walls of the at least one vessel are coated with a coating material, wherein the coating material is selected from: hydrophilic coating material, hydrophobic coating material, low-wear coating material, coating material with user-defined frictional properties.

10. The combi-rheometer device according to claim 2, wherein the second module for capillary-rheological measurements comprises at least one optical measuring apparatus which is coupled with the control module and which is designed to detect samples emerging from a subregion of the second module, wherein the optical measuring apparatus is selected from: laser-based optical measuring apparatus, camera-based optical measuring apparatus.

11. The combi-rheometer device according to claim 2, wherein the second module for capillary-rheological measurements comprises a container which is filled in a user-defined manner with a gas mixture or a liquid or a solid body, in particular a sponge body, with accommodated gas mixture or a solid body, in particular a sponge body, with accommodated liquid, and which is designed to accommodate emerging samples.

12. The combi-rheometer device according to claim 8, wherein the at least one nozzle device is selected from: nozzle device having an opening with a diameter of at least 10 μm; nozzle device with an opening between 0.01 and 2 mm; injection needle with an internal diameter between 0.01 and 2 mm; injection needle with an internal diameter between 0.01 and 2 mm and with a length between 1 and 23 mm; injection needle with an internal diameter between 0.01 and 2 mm, wherein internal walls of the injection needle are at least proportionally coated with a coating material, wherein the coating material is selected from: hydrophilic coating material, hydrophobic coating material, low-wear coating material, coating material with user-defined frictional properties; injection needle with an internal diameter of at least 10 μm, in particular between 0.01 and 2 mm and with a length of at least 10 μm, in particular between 1 and 23 mm, wherein internal walls of the injection needle are at least proportionally coated with a coating material, wherein the coating material is selected from: hydrophilic coating material, hydrophobic coating material, low-wear coating material, coating material with user-defined frictional properties.

13. The combi-rheometer device according to claim 5, wherein the at least one sensor apparatus that is coupled with the control module is selected from: sensor apparatus for measuring forces, sensor device for measuring pressures, sensor device for measuring forces and for measuring pressures.

14. The combi-rheometer device according to claim 4, wherein the respective exchangeable plunger units are externally at least proportionally coated with a coating material, wherein the coating material is selected from: hydrophilic coating material, hydrophobic coating material, low-wear coating material, coating material with user-defined frictional properties.

15. The combi-rheometer device according to claim 4, wherein the combi-rheometer device comprises at least one cleaning device which is configured to clean the connecting unit with the exchangeable plunger unit at least proportionally.

16. The combi-rheometer device according to claim 1, wherein the control module with control program comprises at least one calibration method, so that the combi-rheometer device can be calibrated prior to the measurements, so that rotary-rheometric measurements or capillary-rheological measurements can subsequently be carried out.

17. A method for calibrating a combi-rheometer device for determining rheological properties of samples, including first means for carrying out rotary-rheometric measurements, second means for carrying out capillary-rheological measurements, a shared drive unit and a shared control module with control program which can be provided and used in a user-defined manner in each case both for the first means and for the second means for the purpose of the respective measurements, comprising:
providing and activating a combi-rheometer device;
carrying out rotary-rheometric measurements or capillary-rheological measurements, wherein in each case no sample is inserted;
determining results of the measurements;
storing the results of the measurements in the control module with control program, so that these results can be provided for following measurements with samples.

18. The method according to claim 17, which furthermore comprises:
providing a sample which includes a defined quantity of a rheologically known sample material;
inserting the sample into the combi-rheometer device;
determining results of the measurements; and
storing the results of the measurements in the control module with control program, so that these results can be provided for following measurements with samples.

19. The combi-rheometer device according to claim 2, wherein the drive unit comprises a connecting unit with an exchangeable plunger unit which is configured to transmit movement pulses of the drive unit to the respective first or second means in a user-defined manner, so that owing to the transmission of user-defined movement pulses, respective rheological measurements can be carried out, wherein the movement pulses are selected from: rotary movement pulses, vertical movement pulses, horizontal movement pulses, rotary and simultaneously vertical movement pulses.

20. The combi-rheometer device according to claim 2, wherein the combi-rheometer device comprises at least one sensor apparatus that is coupled with the control module, which sensor apparatus is configured to be providable and usable in a user-defined manner for the carrying out of rotary-rheometric measurements or for the carrying out of capillary-rheological measurements.
